(19) United States
(12) Patent Application Publication
(10) Pub. No.: US 2007/0283440 A1
(43) Pub. Date: Dec. 6, 2007

(54) Method And System For Spam, Virus, and Spyware Scanning In A Data Network

(75) Inventors: Hao Hai Yao, San Jose, CA (US); Gordon Lu, Saratoga, CA (US); Rahul Patil, Sunnyvale, CA (US); Baodung Nguyen, San Jose, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Anchiva Systems, Inc.

(21) Appl. No.: 11/744,055

(22) Filed: May 3, 2007

Related U.S. Application Data
(60) Provisional application No. 60/746,281, filed on May 3, 2006.
(60) Provisional application No. 60/746,286, filed on May 3, 2006.
(60) Provisional application No. 60/746,288, filed on May 3, 2006.

(51) Int. Cl. G06F 12/14

(52) U.S. Cl. 726/24

(57) ABSTRACT

A method and system for spam, virus, and spyware scanning in a data network are disclosed. In one embodiment, the method comprises receiving a data packet. A character sequence is created by a first processor from a binary representation of the data packet. The character sequence is sent to a coprocessor. A malware keyword database is scanned for the character sequence with the coprocessor. The character sequence is further processed if the malware keyword database contains the character sequence.

The present application claims the benefit of and priority to U.S. Application No. 60/746,281 entitled “Method And System Of Hardware—Assisted—Anti-Spam (Keyword/Rule) Scanning” filed on May 3, 2006, which is incorporated herein by reference.

The present application claims the benefit of and priority to U.S. Application No. 60/746,286 entitled “Method of Hardware-Assisted-Antivirus Scanning” filed on May 3, 2006, which is incorporated herein by reference.

The present application claims the benefit of and priority to U.S. Application No. 60/746,288 entitled “Method and System of Hardware-Assisted-Anti Spyware Scanning” filed on May 3, 2006, which is incorporated herein by reference.

### FIELD OF THE INVENTION

The field of the invention relates generally to computer systems and more particularly relates to a method and system for spam, virus, and spyware scanning in a data network.

### BACKGROUND OF THE INVENTION

To guard against the malicious attacks of propagating virus, worms, Trojan horses, spy-ware agents, collectively known as malware, a detection system scans the content of network data traffic for signatures and stops their propagation. Contemporary malware software usually traces all accesses to file systems and the most recent event related to network traffic at a user's desktop and at a server, effectively placing the viral analysis in the critical path of any I/O operation. During this I/O operation, the bottleneck results from the contention between generic CPU and the memory bus.

To filter, block and tag spam emails, the detection system that scans for spam keywords and spam rules in the email would suffer the same I/O bottleneck that is described above.

Analyzing the existing techniques of malware detection helps identify the computationally intensive operations to be further mapped for execution on a coprocessor. Much of the information about the existing commercial malware products are slow in processing real time malware attacks and proliferation.

### SUMMARY

A method and system for spam, virus, and spyware scanning in a data network are disclosed. In one embodiment, the method comprises receiving a data packet. A character sequence is created by a first processor from a binary representation of the data packet. The character sequence is sent to a coprocessor. A malware keyword database is scanned for the character sequence with the coprocessor. The character sequence is further processed if the malware keyword database contains the character sequence. The proposed system architecture supports a multi-engine scanner. The spam keywords and spam rules database is also scanned for the character sequence with the same data stream, concurrent to the scanning of the malware keyword database.

The above and other preferred features, including various novel details of implementation and combination of elements, will now be more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 illustrates a block diagram of an exemplary data network and data processing device, according to one embodiment.

FIG. 2 illustrates a block diagram of an exemplary scanning device, according to one embodiment.

FIG. 3 illustrates a block diagram of an exemplary coprocessor architecture, according to one embodiment.

FIG. 4 illustrates a diagram of an exemplary malware signature, according to one embodiment.

FIG. 5 illustrates a diagram of an exemplary fragment, according to one embodiment.

FIG. 6 illustrates an exemplary internal content addressable memory, according to one embodiment.

FIG. 7 illustrates an exemplary case of complex dependency, according to one embodiment.

FIG. 8 illustrates an exemplary short fragment descriptor table, according to one embodiment.

FIG. 9 illustrates an exemplary method of spam scanning, according to one embodiment.

FIG. 10 illustrates an exemplary memory block that allows a multi-engine scanner to concurrently reference different data for antivirus and antispam modes of operation, according to one embodiment.

### DETAILED DESCRIPTION

A method and system for spam, virus, and spyware scanning in a data network are disclosed. In one embodiment, a method comprises receiving a data packet. A character sequence is created by a first processor from a binary representation of the data packet. The character sequence is sent to a coprocessor. A malware keyword database is scanned for the character sequence with the coprocessor. The character sequence is further processed if the malware keyword database contains the character sequence.

The present method and system are based upon hardware and a pre-indexed large content keyword database, in conjunction with behavioral modeling in analyzing network traffic patterns to effectively block malware at the multiple gigabit line rate. Additionally, the present method and system scale the keyword database to tens of millions of entries, without incurring a performance penalty while keyword databases linearly increase, as malware types explode when data is being accumulated at an exponential growth path.

The coprocessor offloads all the keyword matching code from the main processor. The coprocessor is used not only for simple keyword matching but for other more complicated tasks, like sequence matching, string search, etc. The coprocessor implements various computational primitives for string search, string comparison, etc.

Sequence matching is used to detect malicious programs. In essence, a malware program is characterized by a unique sequence of characters, extracted from its binary representation. The file containing such sequence is considered as “infected”. Thus an Anti-malware program scans all the suspicious files, attempting to match any of the keywords from the keyword database. According to one embodiment, algorithms are implemented in coprocessors, with each coprocessor supporting multiple engines, and the keyword database is pre-indexed in custom external memory of DDR, QDR and T-CAM, all of those components acting as structured pattern storage units that work in conjunction with the storage units already in existence (hash index) inside the co-processors. This provides multiple gigabit line rate scanning throughput for real time malware detection, blocking, quarantine and deletion capabilities.

The present method and system achieves multiple gigabit line performance with application to antispam, antispyware, and antivirus. It also extends to Trojans, malware, and malicious attacks.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

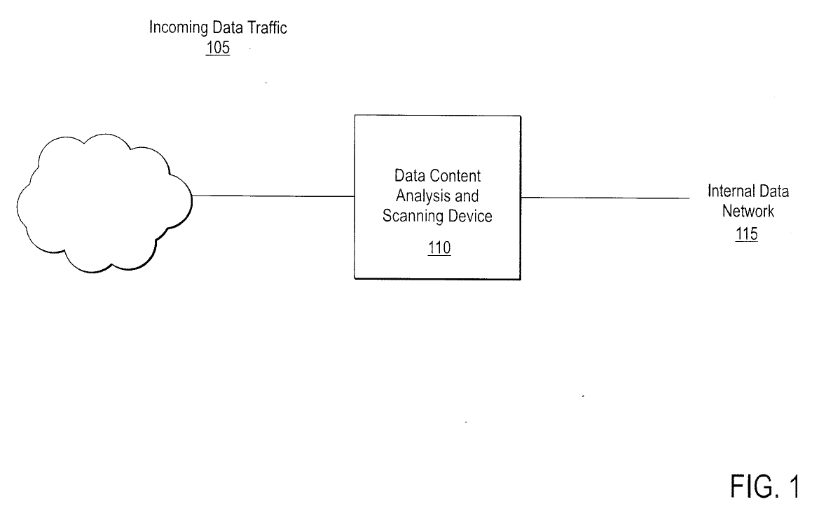

FIG. 1 illustrates a block diagram of an exemplary data network and data processing device, according to one embodiment. Incoming data traffic 105 may be packet data that contains e-mail from the Internet or other data network. Scanning device 110 analyzes the data to detect and eliminate malware before reaching an internal data network 115. Internal data network 115 may be a local area network for a business, enterprise network, or similar secure data network.

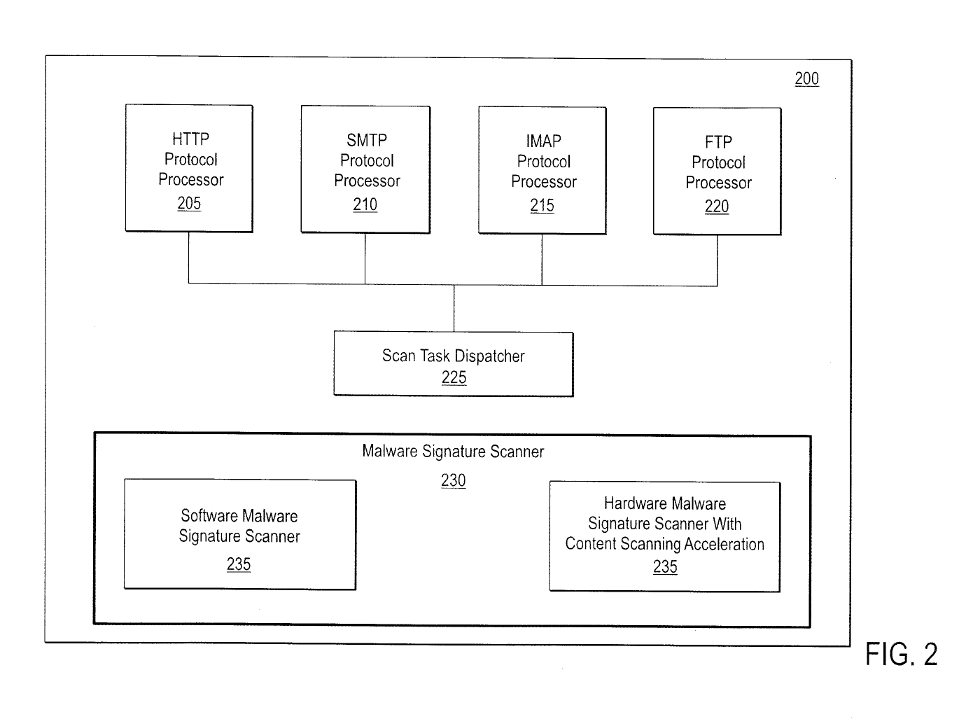

FIG. 2 illustrates a block diagram of an exemplary scanning device, according to one embodiment. The scanning device 200 comprises various protocol processors, such as an HTTP Protocol Processor 205, SMTP Protocol Processor 210, IMAP Protocol Processor 215, and FTP Protocol Processor 220. The scanning device also includes a scan task dispatcher 225. A malware signature scanner 230 has a software signature scanner 235 as well as a hardware signature scanner 236. Data packets enter the scanning device from a network interface (not shown). As each data packet is received, it is classified and then dispatched to the appropriate protocol processor—HTTP 205, SMTP 210, IMAP 215, or FTP 220. Once the appropriate protocol processor receives data packets, it begins assembling the fragmented packets into a coherent stream. A hash-code checksum is computed for the stream. The stream is sent to the software malware signature scanner 235 or to the hardware accelerated malware signature scanner 236 for malware scanning.

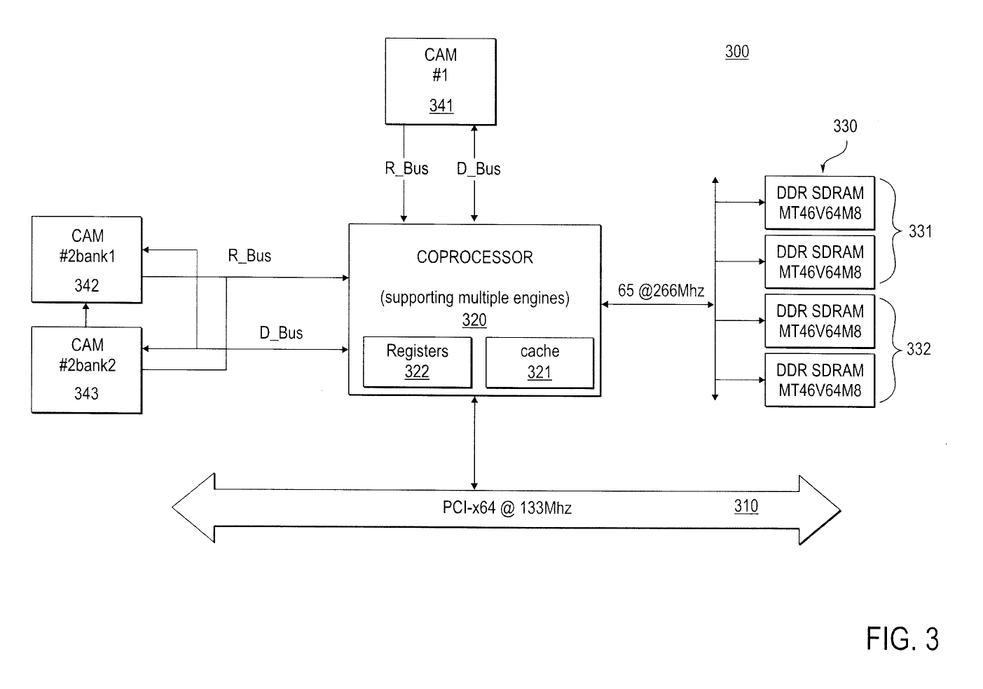

FIG. 3 illustrates a block diagram of an exemplary coprocessor architecture, according to one embodiment. Coprocessor architecture 300 includes a CPU bus 310, coprocessor 320, RAM 330 and external Content Addressable Memory (CAM) 341-343. The coprocessor 320 has private RAM 330, divided into two parts. The first RAM partition 331 contains the string block to be checked and transferred via a DMA channel between the main and coprocessor memories. The second RAM partition 332 is initialized during the boot with the keyword tails arrays. The coprocessor cache 321 is big enough to hold the minimum block of input data.

CAM 341-343 implements fast searches, along with a DFA (discrete finite automata). It allows for a fast search of the whole memory content with a single memory access (without a miss).

The coprocessor 320 is capable of asynchronous operations. It supports the pipelined mode of operation, so that while searching for the first match, the next addresses can be provided to perform the next search. The coprocessor 320 has several registers 322 to receive parameters from the CPU. The registers 322 are grouped in register files, each one containing two registers. These registers 322 are used for the input by the CPU to pass the memory ranges, and for the output by the coprocessor 320 to pass the resulting offset and pointer to the matched string. An additional register is used as a flag register to point to the active register file. This is useful for pipelining the string matching requests, so that the next address range is set by the time the coprocessor completes the current run. In addition, the interrupt line is set in both directions to support asynchronous operation: an interrupt is issued by the CPU to the coprocessor 320 to indicate that the data is ready for processing, and by the coprocessor 320 to the CPU to indicate the completion of the operation.

By combining the accelerated substring search with a pre-scan phase, processing emails web traffic, and cellular phone messages, etc., spam scanning is significantly accelerated.

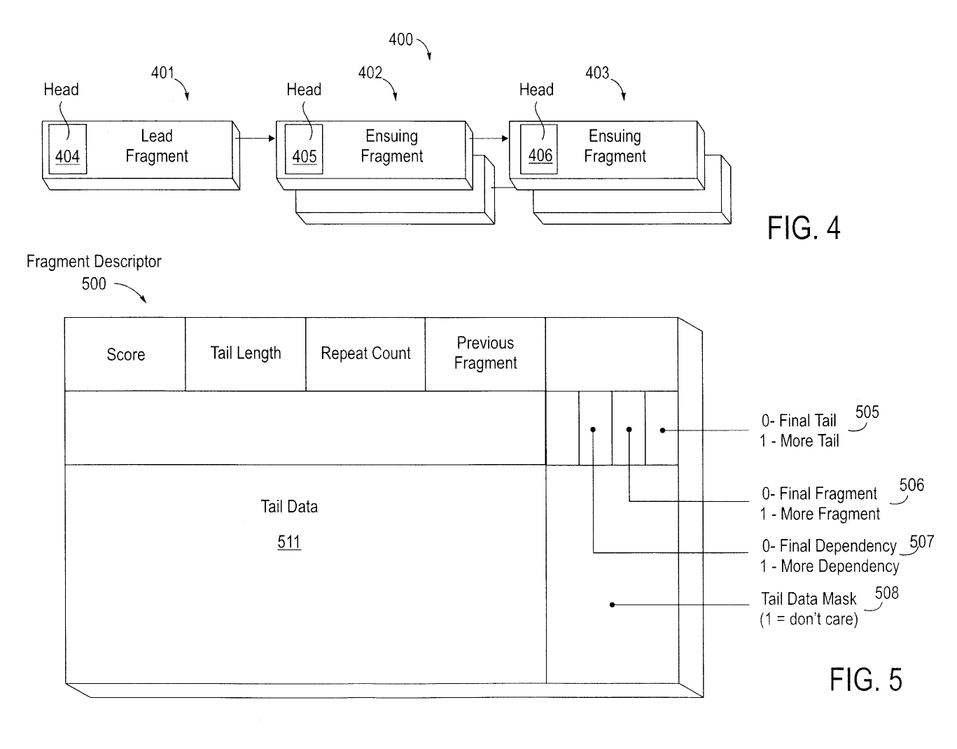

In a pattern database, there are potentially hundreds of thousands of malware signatures. FIG. 4 illustrates a diagram of an exemplary malware signature 400, according to one embodiment. A signature 400 consists of one or more fragments. For example, signature 400 includes lead fragment 401, followed by ensuing fragments 402, 403. A fragment is represented by a head 404-406 and a tail 401-403. In general, there could be multiple-tails for the lead and ensuing fragments.

FIG. 5 illustrates a diagram of an exemplary fragment 500, according to one embodiment. Fragment 500 could be lead fragment 401 (including head 404).
A previous fragment field 501 indicates the fragment number that has to match before a search for the current fragment should proceed.
A repeat count field 502 indicates the number times the previous fragment has to repeat without any gaps.
A tail disposition field 505 indicates whether there are multiple tails for the current head.
A fragment disposition field 506 indicates whether this is the final fragment in the signature.
A tail data mask field 508 contains the mask data for the data with one bit controlling a byte in the tail data.
A minimum offset field 510 indicates the minimum number of bytes to skip before the search for the current fragment is valid.
A maximum offset field 509 indicates the maximum number of bytes beyond which the search should stop and the current search is not considered a match.

In the case of a single-fragment signature, the offsets are not specified and the hex value of 0xFFFFFFFF is used in previous fragment field 501, maximum offset field 509 and minimum offset field 510 to indicate this condition. The repeat count field 502 is set to zero.

For multi-fragment signatures, such as signature 400, the descriptors for the ensuing fragments contain the minimum and maximum offsets, for offsets that are not specified, the search continues to the end of the packet data or until a match is found. The tail data mask field 508 is set to one (or don't care).

For the case where there are multiple tails for a head, such as fragment 402, the search continues until a match is found or no match is found in any of the multiple tail data-descriptors. The tail data mask field 508 is set to one (or don't care).

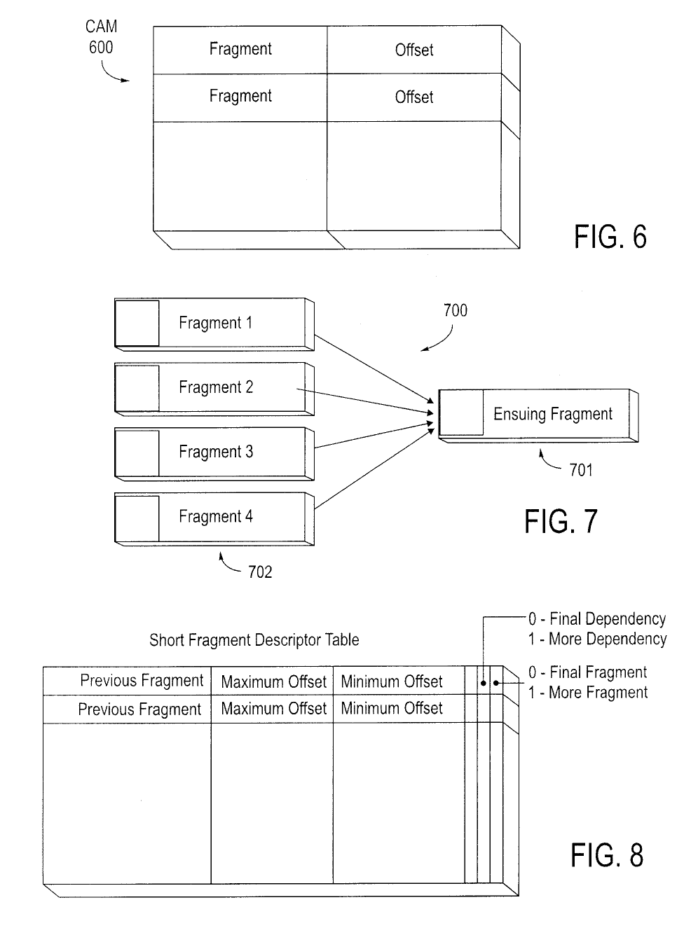

FIG. 6 illustrates an exemplary content addressable memory 600, according to one embodiment. A CAM 600 may be internal to the coprocessor 420 and is used to track the fragments found. CAM 600 may be used for CAMs 341-343. The CAM 600 stores the fragment number that has been found and a four-byte location of the packet data where the fragment is found. The use of an internal CAM allows the internal CAM search to be completed without a long multiple-cycle search process.

If a fragment is hit more than once, the internal CAM is updated with the latest location where it is hit and no new entry is appended.

FIG. 7 illustrates an exemplary case of complex dependency 700, according to one embodiment. Multiple lead or ensuing fragments 702 may fan into a single ensuing fragment 70 1. All the multiple dependent records associated with a fragment are grouped together and occupy consecutive tail data record locations in the onboard memory.

FIG. 8 illustrates an exemplary short fragment descriptor table 800, according to one embodiment. In the pattern database 800, there are a small number of short fragments that are a few bytes long. These fragments cause a high number of CAM 600 hits during a typical scan task. The table 800 contains the descriptors for the short fragments minus all the tail data.

Pattern matching tasks are sent to the coprocessor scanner 235 using a task queue that resides in host memory. The descriptor base points to the location of the starting address of the task queue. Consumer and producer indices provide the current status of the tasks. The tasks are en-queued from the CPU. The descriptor base plus the index scaled to a word gives the location of the current descriptor to be processed.

The coprocessor scanner 235 updates the consumer index for each task it completes scanning. For very large streams of data, the transfer of data to the coprocessor 235 for scanning may exhaust all available host memory and context resource if it is done in a single large mapping. The task queue and other descriptor memory are not large enough to hold all the data descriptors. The scanning of these streams is performed by spanning multiple suspend/resume operations.

SPAM Processing

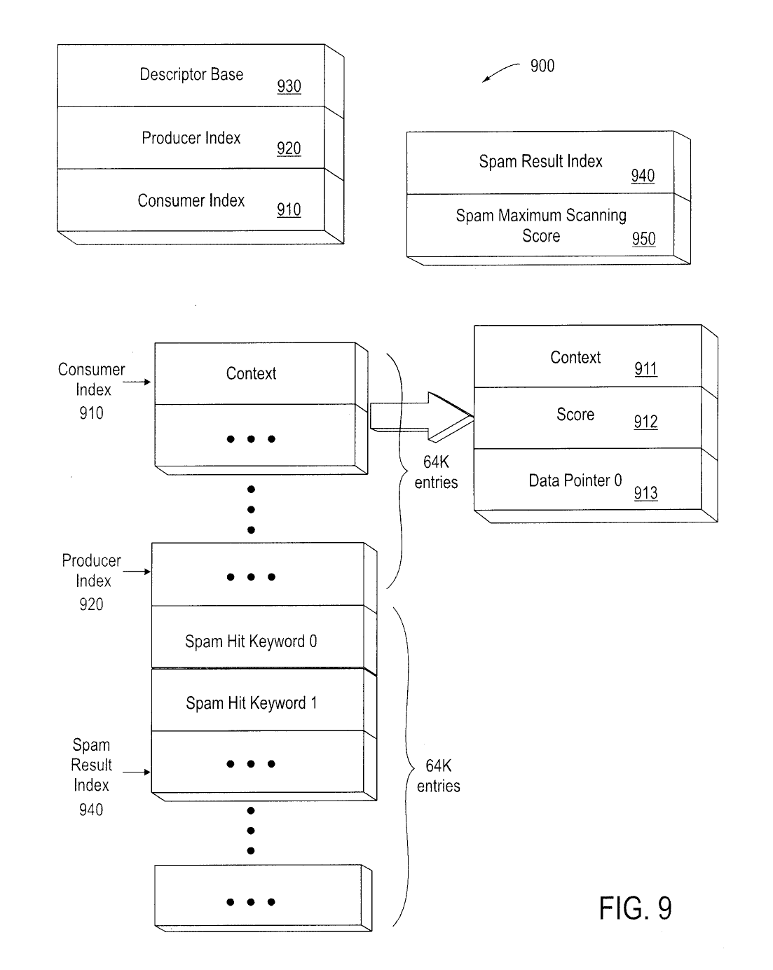

FIG. 9 illustrates an exemplary method of spam scanning 900, according to one embodiment. A spam keyword scanning method 900 uses a score 912 associated with each keyword. This score appears in the descriptor of the last fragment of the keyword. For a single fragment keyword, each hit updates a score 912 that starts at zero for each data packet. Unlike viral keyword scanning, when a match is found for a keyword, the scanner 235 updates the match list and cumulative score 912. The scanning continues until the packet data is exhausted, until 32 matches have been found, or until a specified maximum accumulated score 950 has been exceeded. At the end of a scanning task, the scanner 235 replaces the length field 503 with the accumulated score 912 and returns the list of matches it has found. A result array in memory is allocated together with a descriptor memory block 930 during initialization. The array resides at the next consecutive memory block that is 64K (65536) word entries beyond the start of the descriptor array 930. The spam result index 940 points to the next unused entry. Zero indicates the first entry in the array and is the value of the index immediately after initialization.

The scanner 235 fills in the keyword hits using the number corresponding to the CAM 341-343 search results up to the first 32 hits. It increments this index and handles wrap around. The end of this list for each packet scanned is indicated with an entry having the 31^{st} bit set. The software driver ensures there are 32 or more unused entries before handing the task to the scanner 235 to avoid the condition of overwriting previous results that have not been processed. If there is no match for the entire data packet, a score of zero is returned. When a match occurs multiple times for a keyword, the score 912 for that keyword is accounted for only once. A spam scanning task is indicated with the least-significant bit set in the context field 911. For an anti-virus scanning task, this bit is always zero.

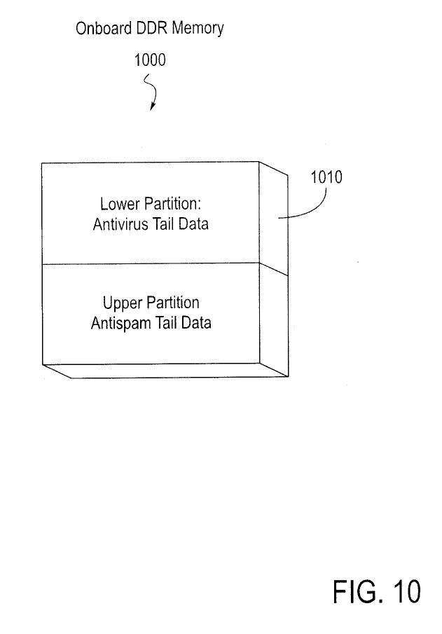

FIG. 10 illustrates an exemplary memory block that allows a multi-engine scanner 235 to concurrently reference different data for antivirus and antispam modes of operation, according to one embodiment. The antispam mode also implies referencing the upper partition 1010 of onboard memory 1000 for the pattern descriptor and tail data.

A method and system for spam, virus, and spyware scanning in a data network have been disclosed. Although the present methods and systems have been described with respect to specific examples and subsystems, it will be apparent to those of ordinary skill in the art that it is not limited to these specific examples or subsystems but extends to other embodiments as well.

We claim:

1. A computer-implemented method, comprising:
receiving a data packet;
creating with a first processor, a character sequence from a binary representation of the data packet;
sending the character sequence to a coprocessor;
scanning a malware keyword database for the character sequence with the coprocessor; and
processing the character sequence if the malware keyword database contains the character sequence.

2. The computer-implemented method of claim 1, wherein processing the character sequence further comprises at least one of: blocking the data packet, quarantining the data packet, and deletion of the data packet.

3. The computer-implemented method of claim 2, wherein the malware keyword database contains entries relating to at least one of: trojans, spyware, spam and viruses.

4. The computer-implemented method of claim 1, further comprising pre-indexing the malware keyword database.

5. The computer-implemented method of claim 4, further comprising malware string searching.

6. The computer-implemented method of claim 1, wherein the malware keyword database is scanned in a single memory access.

7. The computer-implemented method of claim 1, further comprising maintaining a score associated with a spam keyword in the malware keyword database.

8. A computer program product tangibly embodied in a computer readable medium, the computer program product comprising instructions operable to cause a data processing equipment to:
receive a data packet;
create with a first processor, a character sequence from a binary representation of the data packet;
send the character sequence to a coprocessor;
scan a malware keyword database for the character sequence with the coprocessor; and
process the character sequence if the malware keyword database contains the character sequence.

9. The computer program product of claim 8, wherein processing the character sequence further comprises at least one of: blocking the data packet, quarantining the data packet, and deletion of the data packet.

10. The computer program product of claim 9, wherein the malware keyword database contains entries relating to at least one of: trojans, spyware, spam and viruses.

11. The computer program product of claim 8, further comprising instructions operable to cause the data processing equipment to pre-index the malware keyword database.

12. The computer program product of claim 11, further comprising instructions operable to cause the data processing equipment to string search malware.

13. The computer program product of claim 8, wherein the malware keyword database is scanned in a single memory access.

14. The computer program product of claim 8, further comprising instructions operable to cause the data processing equipment to maintain a score associated with a spam keyword in the malware keyword database.
